(19) United States
(12) Patent Application Publication
(10) Pub. No.: US 2002/0126688 A1
(43) Pub. Date: Sep. 12, 2002

(54) Bitstream management

(76) Inventors: Per Lindgren, Stockholm (SE); Christer Bohm, Stockholm (SE); Lars Gauffin, Ronninge (SE)

Correspondence Address: SKJERVEN MORRILL LLP, 25 METRO DRIVE, SUITE 700, SAN JOSE, CA, 95110, US

(21) Appl. No.: 09/933,925

(22) Filed: Aug. 21, 2001

Related U.S. Application Data
(62) Division of application No. 09/142,740, filed on Sep. 15, 1998.

(30) Foreign Application Priority Data
Mar. 25, 1996 (SE) 9601132-5
Mar. 25, 1997 (SE) PCT/SE97/00523

(51) Int. Cl. H04B 7/212

(52) U.S. Cl. 370/442; 370/386

(57) ABSTRACT

The present invention relates to the transferring of data via a shared medium between nodes in a time multiplexed network, wherein said data is transferred in time slots in one or more bitstreams. To obtain an efficient network, the synchronization of parallel bitstreams is of great importance. A high degree of utility is provided by time slot reuse. The above-mentioned characteristics are obtained by regenerating each bitstream as a whole in a node. This also solves problems with dispersion, attenuation, clock gap and clock extraction. The invention is preferably provided using WDM in a DTM network.

### FIELD OF INVENTION

The present invention relates to methods, devices and systems for more efficient use and synchronisation of parallel bitstreams in circuit switched time multiplexed networks, wherein data are transferred between nodes via a shared medium (e.g. a network with a bus or ring topology) and multi access, preferably a network of the DTM (Dynamic Synchronous Transfer Mode) type.

### TECHNICAL BACKGROUND AND PRIOR ART

New communication networks and protocols are being developed continuously by the telecommunication industry and the academic world. The technology is ever changing, and new results and discoveries are important to software application developers, whose task it is to integrate real time sound communication, real time video communication and asynchronous communication services. The applications are provided on a wide spectrum of network terminals. The terminals may be almost any electronic devices, including small cellular phones, television sets, multimedia workstations or supercomputers worth millions of dollars. The terminal hosts differ from each other by several magnitudes regarding the demands on processor capacity and service levels.

The two basic types of network are connection-oriented, circuit switched networks, which are used e.g. in conventional telephony, and connectionless, packet switched networks, which may be exemplified by the Internet.

When a circuit switched network is used for data communication, the connections are left open between bursts of information, which leads to waste of resources. This situation arrises as a result of the connect and disconnect operations being time consuming compared to the dynamic variations of the user's needs. Another source of waste of resources in circuit switched networks is the limitation inherent in the fact that it is only possible to have symmetrical duplex channels, which means that only half the resources allocated to the connection are used when the information flow goes in only one direction.

A packet switched network, on the other hand, lacks means for reserving resources, and has to add information to the header of each message before sending it. Moreover, delays in a packet switched network cannot be predicted with adequate accuracy, and some packets may even be lost during transfer because of buffer barriers, so called “buffer overflow”, or because of destroyed information in the header of the packet. These two latter aspects make it difficult to support real time services in a packet switched network.

In order to address the above mentioned problem, the communication industry is focusing on the development of so called ATM systems (Asynchronous Transfer Mode). The CCITT (International Telegraph and Telephone Consultative Committee) has also accepted ATM as a standard in B-ISDN (Broadband-Integrated Services Digital Network). ATM is connection-oriented and establishes a channel, in similar to a circuit switched network, but uses small packets of fixed size; which are called cells, for information transfer. The packet oriented nature of the ATM system requires that the network provides mechanisms such as buffer resources and link managers in order to be able to guarantee real time demands on a connection.

A new solution, DTM-Dynamic synchronous Transfer Mode (See C. Bohm, P. Lindgren, L. Ramfelt and P. Sjödin, “The DTM Gigabit Network”, Journal of High Speed Networks, 3 (2), 109-126, 1994 and L. Gauffin, L. Håkansson and B, Pehrson, “Multi-gigabit networking based on DTM”, Computer Networks and ISDN Systems, 24 (2), 119-139, April 1992) aims to meet the demands on real time characteristics and focuses on circuit switched networks and therefore has to address the typical problems of circuit switched networks described above. A new protocol for managing a shared medium, especially an optical wave conductor through which at least some nodes communicate on a shared wavelength, is also used, which means that the problems of controlling shared media also have to be taken into consideration.

DTM is a circuit switched network designed for use in public networks as well as in local area networks (LAN). DTM uses channels as communication abstraction. These channels differ from telephony circuits in different ways. First, the connection delay is so short that resources can be allocated or disallocated dynamically depending on the user's needs. Second, the channels are of the simplex type and therefore minimise extra costs. Third, multiple bitrates are provided, which make it possible to support large variations of the user's capacity requirements. Finally, the channels are multicast, which permits more than one end destination.

Circuit switched DTM channels show many advantageous characteristics. There is no transfer of control information after channel establishment, which results in a high degree of utilisation of the network resources when transferring large amounts of data. The support for real-time traffic is built in and there is no need for policing or flow management within the network. The transferring delay is small, and there is no possibility of loss of data as a consequence of buffer overflow as in ATM. The bit error frequency depends on the underlying link technologies, and the switching is fast and simple as a result of the strict reservation of resources at channel connection. DTM shows good characteristics within fields where traditional circuit switched networks fall short; dynamic allocation of resources, channel set-up delays, and as networks with a shared medium.

The basic topology of a DTM network is preferably a bus with two unidirectional optical fibres connecting all nodes, but it can also be realised by any other kind of structure, for instance, a hub or ring structure. The DTM medium access protocol is a time-division multiplexing scheme. Moreover, wavelength division multiplexing can be used on a bus in the form of an optical fibre in order to increase the network capacity. The bandwidth of the bus is divided into 125 μs cycles, which in turn are divided into 64-bit time slots. The number of slots in a cycle thus depends on the networks bitrate. The slots are divided into two groups, control slots and data slots. Control slots are generally, but not necessarily, static and used to carry messages for the network's internal operation. The data slots are used for the transfer of user data.

In each network node there is a node controller, which controls the access to data slots and performs network management operations.

Control slots are used exclusively for messages between node controllers. Each node controller has write permission to at least one control slot in each cycle, which it uses to broadcast control messages to other nodes. Here, broadcast refers to sending information to all downstream nodes on a bus, as the transmission medium is unidirectional. Since write access to control slots is exclusive, the node controller always has access to its control slots regardless of other nodes and network load.

In order to achieve large data transmission rates, there are two ways of approach, either to increase the frequency, e.g. the number of transferred bits per second, or to use parallel transmissions of data. Since the cost of electronic equipment increases rapidly with increasing data reception rates, there is an evident advantage to using parallel transmissions of data in order to achieve very large data transmission rates. Furthermore, state-of-the-art technology for achieving the optimal rate of transferred bits per second may of course be used, but still the overall transmission rate will be multiplied by parallel transmission of data.

To transfer data in parallel streams, two kinds of parallel systems may be used, among other, with the technology of today; bitstreams may be transferred in physically separated carriers, so called SDM (Space Division Multiplexing) or a carrier in which different bitstreams are sent on different wavelengths or frequencies may be used, so called WDM (Wavelength Division Multiplexing. Of course, a combination of these two techniques may also be used in order to obtain optimal use of the network. In this context, the term “parallel bitstreams” refers to both SDM and WDM.

A number of advantages of using DTM in connection with parallel data transmission can be identified. DTM uses a shared medium with separated control and data channels, which frees a node from the necessity of supervising all bitstreams in order to identify possible flags or headers. DTM is connection-oriented and uses TDM (Time Division Multiplexing) channels, which means that the node knows where and when data is to be read or written. Through TDM, several connections may be made on a single bitstream, which results in high channel resolution. Most WDM structures use one wavelength as the lowest resolution rate.

All of the above make DTM especially suitable for parallel data transmission. There are, however, no obstacles to using the methods proposed in this invention for other types of time multiplexed protocols.

In the broadband networks of today and tomorrow, the majority of the nodes will be broadband receivers, but narrowband senders, such as in Video on Demand applications. The greatest need for most of the nodes should therefore be for the ability to receive large amounts of data in a short period of time, rather than the ability to send large amounts of data.

The proposed inventions is not limited to this kind of node, but is especially suitable to handle the type of applications where the reception of data is broadband compared to the sending of data.

Furthermore, there exists a number of larger and smaller problems associated with the use of parallel bitstreams. One of these problems arrises when the recipient has to change bitstreams in order to read new data. Before the data can be read, the recipient has to synchronise its clock to the new bitstream. This may take some time, especially if the recipient has to synchronise to other than the bit clock, for instance to time slots and frames. Another problem is that time slots in the different parallel bitstreams may drift in relation to each other. If a node then is to read time slots from different parallel bitstreams, there is a risk that they may overlap and cause a conflict if the node only has the ability to read from one bitstream at a time.

A difficult problem when transferring data optically is dispersion, i.e. the effect of the light having different propagation velocity at different wavelengths, which means that two wavelengths, which are synchronised when sending, not necessarily are synchronised when receiving.

Complexity increases if optical bypass is used on a shared medium. Optical bypass is advantageous for several reasons. Also, if a node error occurs, data that is optically bypassed will not be affected by the node error and may pass the node. This makes it possible for other nodes that communicate on bypassed wavelengths to continue communicating regardless of the node error.

When transmitters are to share a wavelength using optical bypass, there is a number of areas to be taken into consideration. Data having its origin at different distances from the receiver will show different attenuation, which may cause difficulties when reading the data. Since data is generated in different nodes having different local clocks, gaps between clocks may occur, and since different local lasers are used, which may show small differences in wavelength, there may arrise so called intra wavelength dispersion, which means that closely spaced time slots may overlap and slide into each other. Different bitstreams generated with different clocks may also drift in relation to each other, which may lead to so called “slip” problems when switching/rerouting, or to so-called “slot contention”, i.e. collisions occurring when the receiver is forced to receive several time slots at different wavelengths at the same time.

Prior, attepmts have been made to solve some of the above problems by the introduction of the so-called “guard bands” between messages on one or several bitstreams or wavelengths, i.e. time slots containing data have been separated from each other by empty time slots in order to allow some drift without the risk of overlapping of bitstreams or time slots.

In the First IEEE International Workshop on Broadband Switching Systems, April 1995 in Poland, page 182, wavelength reuse in systems with parallel bitstreams in an optical WDM network is described.

The Swedich patent SE 460 750 describes a telecommunications system in which time multiplexed speech and data information is transmitted over buses in a matrix network.

The Swedich patent SE 468 495 describes a method and a device for synchronisation of two or more time multiplexed communication networks.

### SUMMARY OF THE INVENTION

The presesnt invention addresses problems described above and in the following, for instance problems with bitstreams drifting in relation to each other, problems with dispersion and especially intra wavelength dispersion, problems with different attenuation of data emanating from different nodes, problems with gaps between clocks and problems with recovering the clock from the incoming data.

Equipment to be sold for home use, for instance TV-sets, videos, computers etc, is very price sensitive. The manufacturing of this equipment for as attractive a price as possible is a very important factor of competition in the home electronics sector. For nodes to be used in broadband applications the problems becomes extra large, since top-of-the-art technology with large demands on hardware and software must be used for these nodes. The problem of high costs for broadband nodes can partly be solved by giving the node the possibility of reading data from several bitstreams but transmitting data on only one or a few bitstreams.

Yet another problem is how to derive the clock. The solution uses a plesiosynchronous mechanism for providing bit synchronisation, which means that the clock is derived from the bitstream. This means that the bitstream must have a given number of clock edges in order to trigger PLL (Phase Locked Loop) and a relatively high DC stability. This can be achieved by the coding of data and by sending the clock edges in empty time slots. If a pure draining mechanism is used with optical bypass, an empty time slot must not contain “light” when a sender is adding data to a time slot. In order to solve this problem, a very fast optical 2:1 multiplexor, able to switch on separate bits, must be used. This is technically extremely difficult and also very costly.

An object of the invention is therefore to efficiently use parallel bitstreams, e.g. WDM or SDM or a combination thereof, without the occurence of problems with attenuation, clock gaps, clock derivation, drifting or dispersion, and at the same time to achieve a cost-effective solution.

Another object of the invention is to improve the communication capacity of a time multiplexed network, wherein the time is divided into cycles, which in turn are subdivided into time slots for the transmission of data and control information, and wherein the network uses a shared medium with multi-access.

According to one aspect of the invention, these problems are solved by all the data in a bitstream being regenerated in one and the same node, wherein the incoming bitstream is stopped from further propagation along the shared medium, and is instead completely regenerated in the node. Thus the node is prevented from writing data in the wrong time slots, which may be due to that parts of the bitstream are not synchronised with the write function of the node.

According to another aspect of the invention, an improved management of the network is achived by a master node providing a trigger bitstream with synchronisation pattern. Slave nodes, each being responsible for the synchronisation of a respective bitstream, synchronise their bit clock to the trigger bitstream and then synchronise the starting point or a frame, in a bit stream associated with the slave node, to the start of a frame in the trigger bitstream.

The method of synchronisation may also be used when each node in a network is transmitting on a separate bitstream, but is reading from several bitstreams.

DTM thus allows an advantageous method of synchronisation, which allows bitstreams to be processed independently, which thus reduces or solves the above mentioned problems.

Synchronisation of parallel bitstreams is very important in order to achieve an efficient network. A master node is appointed to the network and a trigger bitstream is associated to the master node. The master node decides the frame rate in the network by primarily adding to each cycle a starting pattern in the beginning and a number of filling slots at the end. The filling slots function to absorb differences in clock frequency of different bitstreams. Moreover, a number of slave nodes are chosen, and one or more bitstreams are associated to each slave node. Each slave node has to be able to write in its associated bitstreams. The speed of the bitstream associated to the slave node should be a multiple of the speed of the trigger bitstream. The slave node listens to the bitstream of the master node, or to the bitstream of another slave node synchronised to the master node, and synchronises its own bitclock thereto. The slave node preferably adds a similar starting pattern and filling slots to its bitstream, in a similar way as the master node added starting patterns and filling slots to the trigger bitstream, and synchronises the start of a frame in its associated bitstream to the start of a frame on the trigger bitstream. Thus all parallel bitstreams in the network are synchronised.

Furthermore, the communication between the nodes connected to the bus can be of different types, e.g. local communication or remote communication. The DTM cycles travel along the entire bus, which, for local communication, may result in inefficient use of the network resources, since only nodes on one segment use the communication resources.

According to yet another aspect of the invention, further possibilities are provided by reuse of time slots. Hence, according to the invention, several users may use the same bitstream by time slot reuse.

According to the invention, wavelengths are reused between different clusters of nodes by the use of an optical filter for terminating a wavelength. The clusters may be rearranged dynamically during network operation according to the current network traffic pattern. The configuration of the clusters are controlled by the node controllers, which use status information, sent from the nodes connected to the bus, in order to determine how the clusters should be configured.

Between each cluster there is a filtering means provided to the bitstreams which are to utilise time slot reuse. The filtering means prevents further transmitting of the bitstream downstream. Within each separate cluster the same bitstream can then be used for communication between nodes situated within the cluster. For the communication between different clusters, the node representative is used as a relay for the transmission of logical channels.

Time slot reuse is thus utilised by arranging groups of nodes into clusters, and to each cluster assigning a node representative that communicates with other node representatives. By also introducing node representatives within a cluster of nodes, the setup of other nodes within a cluster is made easier. The node representative is responsible for all long distance communication, on a separate bitstream.

The principles of time slot reuse and the use of clusters, synchronisation and regeneration can, according to the invention, is preferably combined in order to achieve the desired functionality.

Preferably, the most upstream provided node in a cluster (the cluster master node) starts the cycle on the cluster wavelength. If the master node of the cluster is the most upstream node on the entire bus, it is preferably advantageously used as a reference for the starting of cycles on the bus. Other cluster master nodes can start cycles that are synchronised to the most upstream node. They may also start cycles that are not synchronised to other cycles. If the network traffic is to be switched/rerouted between different clusters or wavelengths, the bitstream cycles for different clusters and and wavelengths are preferably synchronised.

According to an embodiment of the invention, a node receives several parallel bitstreams, which are transmitted by one or several carriers, for instance an optical fibre that transmits two or more bitstreams on two or more respective wavelengths. One or some of these bitstreams is, according to an earlier agreement between the nodes in the network, the bitstream(s) in which the node uses one or more time slots to communicate with other nodes downstream, let us denote this or these bitstreams B1. B1 is separated from the other bitstreams B2 in a first means and is directed into the node. The first means is also responsible for stopping B1 from further transmission along the carrier, i.e. the shared medium. When B1 reaches the node, the time slots can be read, and a modified bitstream B1′ is obtained by the node writing data into time slots used according to a previous arrangement. The other bitstreams B2 can be directed into a reading device that allows the node to read data from these bitstreams without essentially affecting them. B1′ is then regenerated as a whole for further trnasmission downstream alonng the carrier.

An advantage to these arrangements is that all the data in a specific bitstream is generated by one and the same node, which prevents intra wavelength dispersion, clock gaps and problems with moderation.

Another advantage is that clock edges can be added to empty time slots in order to guarantee that for instance a PLL unit can quickly extract the clock.

Yet another advantage is the possibility of using time slot reuse. The advantage of using node representatives is that nodes of a simpler construction, for instance including cost-effective low effect or multimode lasers can be used in the nodes in the cluster that are not node representatives.

Another advantage is that transmitters are required only for the bitstreams that the node is communicating with downstreams. A minimised number of transmitters result in reduced costs and thus a less expensive product.

An advantage of the synchronisation is that the above mentioned problems of “slot congestion” and “switch slip” are solved, and that a node thus can read or otherwise use two parallel bitstreams without running the risk of overlap of information, which is not as easily achieved without synchronisation according to this invention.

Exemplifying embodiments of the invention will now be described with references to the accompanying drawings.

### BRIEF DESCRIPTIONS OF THE DRAWINGS

FIG. 1 shows an example of a DTM system according to a preferred embodiment of the invention.

FIG. 2 shows regeneration of bitstreams according to an embodiment of the invention.

FIG. 3 shows an example of table management in a node when regenerating bitstreams according to the invention.

FIG. 4 shows yet another embodiment of the invention.

FIG. 5 shows a frame with parallel bitstreams.

FIG. 6 shows time slot reuse with cluster representatives.

FIG. 7 shows a schematic representation of an embodiment of the invention.

FIG. 8 schematically shows synchronisation according to an embodiment of the invention.

FIG. 9 schematically shows synchronisation according to another embodiment of the invention.

### DETAILED DESCRIPTION OF EXEMPLIFYING EMBODIMENTS

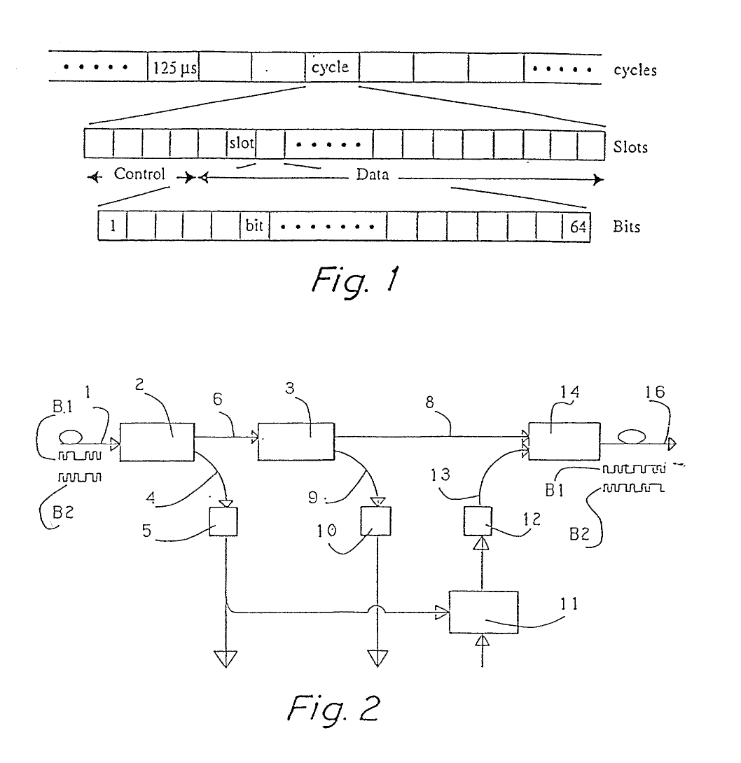

First, a protocol of the DTLM type will be described as an example of a time multiplexed network with reference to FIG. 1. The basic topology for a DTM network is based on a shared medium, e.g. a bus or a ring. In the description, a bus topology will be used. The bus may consist of two unidirectional optical fibres, one in each direction, which connect all nodes to each other. Several buses with different speeds can be connected to form an arbitrary multistage network. Typically, the buses will be connected to form a two-dimensional rectangular mesh. A node at the connection between two buses synchronously switches data between the two buses. This allows for rapid switching with constant delay through the node. On each unidirectional fibre of the bus, several wavelengths can be used for the transmission of data, which increases the network capacity.

The DTM protocol uses a time multiplexing scheme to organise the data on the bus, called DTM medium access control (DTM MAC). As shown in FIG. 1, the bandwidth of the bus is divided into 125 μs cycles, which in turn are subdivided into 64 bit time slots. The number of time slots in a cycle thus depends on the bit rate of the wavelength; for example, there are approximately 12500 time slots per cycle on a wavelength of 6.4 Gbit per second.

FIG. 2 schematically shown an embodiment of the invention wherein a first optical fibre is denoted 1, a first WDM coupler is denoted 2, and a first 1×2 coupler is denoted 3. On the first optical fibre 1, two different wavelengths L1 and L2 are carried, which are used to transmit two bitstreams B1 and B2. B1 is the bitstream that is used by the node for downstream communication. In the first WDM coupler 2, the two wavelengths L1 and L2 are separated, and L1, which is used to transmit B1, is transmitted on a second optical fibre 4 to a first optical/electrical converter 5. From the first converter 5, the bitstream is transmitted electrically further into the node (schematically shown as a downward pointing arrow from the converter 5) wherein data can be read and later written (the upward pointing arrow to the right in the FIG. 1) in previously agreed upon time slots. Note that the incoming bitstream B1 on the wavelength L1 is entirely converted into an electrical bitstream and thus is completely prevented from further propagation along the shared medium. The other wavelength L2, which is used to transmit B2, is in this node only used for the reading of data, which is why it is transmitted on a third optical fibre 6 to a 1×2 coupler 3. The 1×2 coupler 3 divides L2 and further transmits L2 on a fourth optical fibre 8 and a fifth optical fibre 9. The fifth optical fibre 9 is lead to another optical/electrical converter 10. From the second converter 10, B2 is electrically transmitted forward into the node (schematically shown with a downward pointing arrow from the converter 10) so that data can be read from predefinied time slots. In the node, B1 is forwarded to a first 2:1 Mux 11 wherein new data generated in the node (the upward pointing arrow to the Mux 11) is written into B1. From the first 2:1 Mux 11, the modified bitstream B1′ is now forwarded to a first electrical/optical converter 12, which converts the bitstream B1′ into optical mode on the wavelength L1. From the first electrical/optical converter 12, L2 is transmitted on a sixth optical fibre 13 to a second WDM coupler 14. The fourth optical fibre 8 is also provided to the second WDM coupler 14. In the second WDM coupler 14, L1, carried on the sixth optical fibre 13, is brought together with L2, carried on the fourth optical fibre, and these two are further transmitted on a seventh optical fibre 16 to the next downstream node.

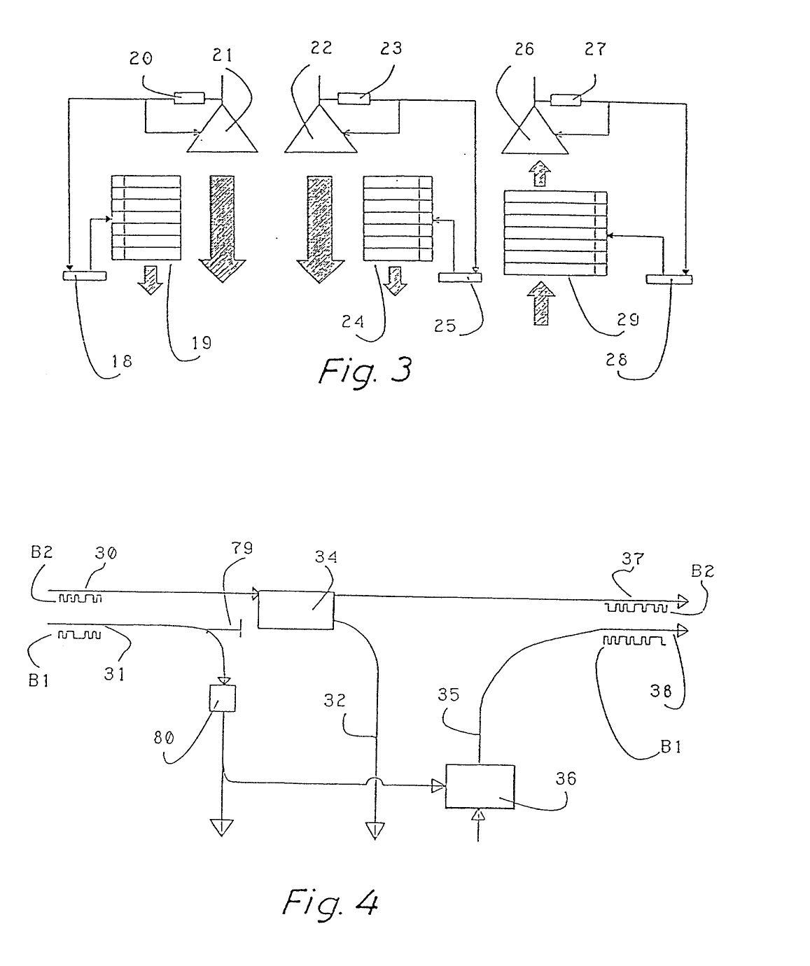

FIG. 3 shows an example of the table management part of a node. This part may be the same regardless of if WDM or SDM is being used. In this embodiment, two parallel bitstreams are received and one is transmitted. Of course, nodes that receive one or more than two bitstreams and transmit none or more than one bitstream may be used as well.

PLL 20, 23 triggers time slot counters 18 and 25 respectively, which point to channel tables 19 and 24, respectively. Every entrance in the channel table corresponds to a time slot in the bitstream. When a flag in any of the channel tables 19, 24 shows that the corresponding time slot is to be read, the associated demultiplexor 21, 22 reads data from the time slot for further processing in the node.

Transmission of data is managed correspondingly. When the node is to transmit data, data is out into the transmission table 29 in the position that corresponds to the time slot to be used for transmission. When the time slot counter 28 points to an entry in the transmission table 29 that has a flag indicating that data is to be sent in this particular time slot, the multiplexor 26 writes data into the time slot. This data is then, for example, transmitted to the multiplexor 11, shown in FIG. 1. The time slot counter is trigged by a PLL 27, which preferably is synchronised to PLL 20 or 23.

Even if the receivers in FIG. 3 for the sake of clarity are shown as two separate units, they may be combined into a single unit at different levels, for instance into a common control memory or a shared multiplexor for both of the received bitstreams. The units in FIG. 3 can also be obtained as integrated parts of other units, as for instance those shown in FIG. 2 above and FIG. 4 below.

In FIG. 4, an example of SDM with electrical transmitters is shown. The bitstreams B1 and B2 are carried on separate electrical carriers 30 and 31. The bitstream B1 is transmitted into a regeneration means 80, which recreates the bitstream B1. From the regeneration means 80, the bitstream B1 is transmitted into the node. The bitstream B2 is transmitted to a distribution means 34. The bitstream B2 is transmitted from the distribution means 34 partly into the node (downward pointing arrow) and partly further downstream on the carrier 37 to the next node in the network. The distribution means 34 may of course be as simple as a T-coupling, but it can also be a more advanced equipment suited to handle special problems which may arise in connection with high bitstream speeds.

From the regeneration means 80, the bitstream B1 is also transmitted to a multiplexor 36, which multiplexes write data from the node (upward arrow) with data from the received bitstream B1. From the multiplexor 36 the modified bitstream is further transmitted downstream on the carrier 38.

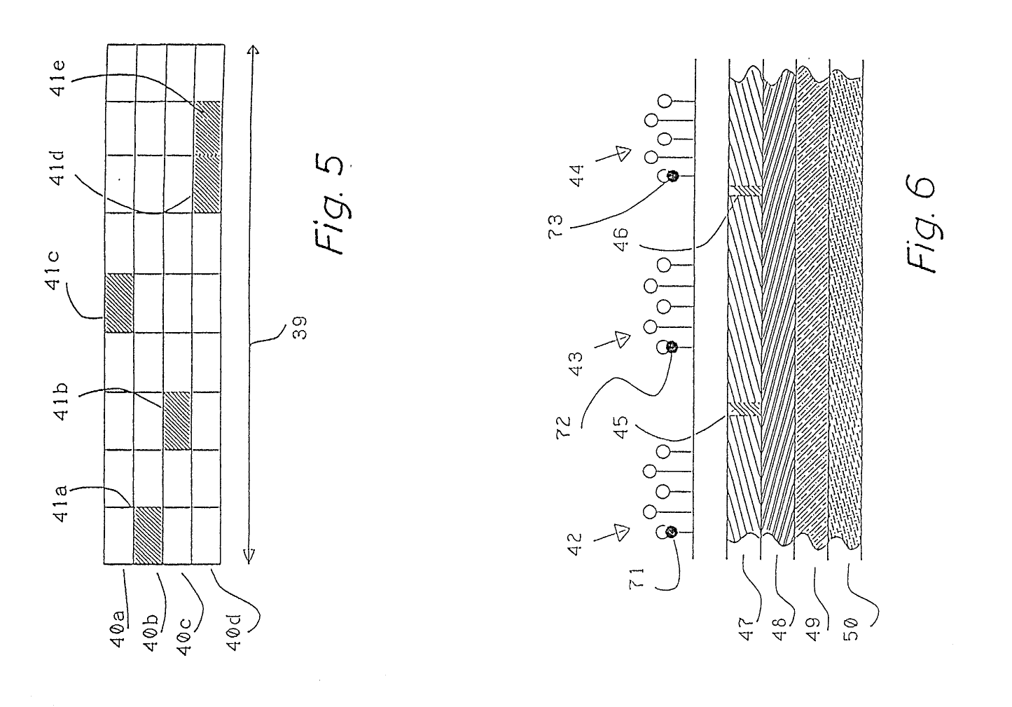

In FIG. 5, an example of a shared medium with parallel bitstreams 40a-40d transmitted on four different wavelengths in a single optical fibre is shown. In a schematic frame or cycle 39, containing nine time slots, five time slots contain information. In FIG. 5, a node is arranged to read data from the time slots 41a-41e from different bitstreams, i.e. on different wavelengths. The time slots containing data are spread out, so that, hopefully, no data slots will reach the node at the same time as other data slots, thus preventing the node from having to receive data on different wavelengths or from different bitstreams at the same time. This is possible since the bitstreams are synchronised to not drift due to dispersion or different bitclocks.

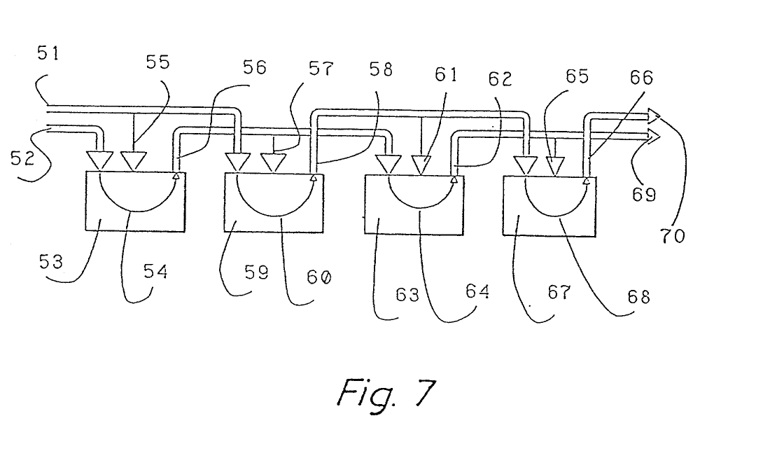

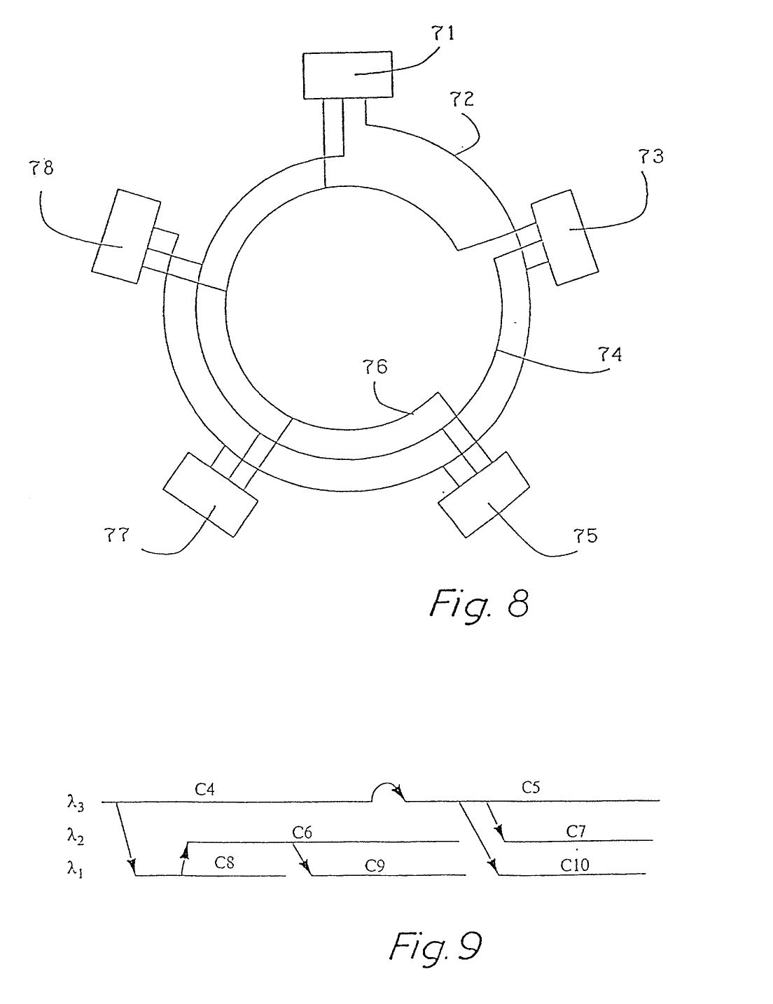

Hence, the invention provides the possibility of efficient use of the resources in a time-multiplexed network with several parallel channels, e.g. different wavelengths or parallel fibres, in a topology with a shared medium. To this end, wavelength or time slot reuse is used, which provides a possibility for the nodes to reuse wavelengths and to form clusters of nodes communicating on specific wavelengths, see FIG. 6. The wavelengths are reused after termination (45, 46).

FIG. 6 shows an embodiment using time slot reuse. Three different clusters 42, 43 and 44, with several nodes in each cluster, use the same bitstream or wavelength 47 for communication within each cluster. This means that a time slot in the bitstream 47 having been used for communication between two nodes in the first cluster 42 does not have to stay unused further downstream, but is reused first in the second cluster 43 and then again in cluster 44.

In order to prevent further propagation of the bitstream and the wavelength 47 downstream, and thereby preventing disturbances in clusters situated downstream, filters 45 and 46 are arranged between the clusters 42, 43, and 44. In each cluster 42, 43, and 44 there is a special cluster representative 71, 72, and 73 for each cluster. In this embodiment, the bitstream 47 is driven by low power lasers, which is possible since the distances within each cluster is relatively short. The cluster representatives 71, 72, and 73 have access to the bitstreams or wavelengths 48, 49, and 50, which are used for long distance communication between the clusters.

The cluster representatives 71, 72, and 73 also function as relay stations for the communication between the clusters. The cluster representatives 71, 72, and 73 are arranged to listen and transmit control information to each other. This means that logical channels are set up by and transmitted via the cluster representatives 71, 72, and 73.

Since the cluster representatives 71, 72, and 73 in FIG. 6 are situated most upstream in each cluster, they generate cycles on their respective wavelengths. The nodes within the cluster 42 use the wavelength 47 in order to communicate, that is, to read and/or write data, with other nodes within the cluster.

The cluster representatives can choose between several different ways of transmitting information between nodes situated in different clusters. One alternative is that communication between nodes in different clusters is switched via the cluster representatives. Another alternative is that the cluster representatives only handle the control signaling for the connection of a specific DTM channel between the nodes in the different clusters wishing to communicate with each other. The node that initiates the communication then transmits, by way of example, an inquiry to its cluster representative and asks the cluster representative to establish the desired channel on a suitable wavelength. The cluster representative manages this by negotiating with the other cluster representatives, and subsequently informs the node of which time slots are to be used for the channel.

Of course, several cluster may form super clusters, and a node may be part of several clusters.

In FIG. 7, a portion of a network is schematically shown using two parallel bitstreams, for example two different wavelengths on one and the same optical fibre, for communication between four nodes, 53, 59, 63, and 67. The first bitstream 51 is read by the nodes 53 and 63, and is then taken in, as a whole, into the nodes 59 and 67. The nodes 59 and 67 thus only use the bitstream 51 for the communication with the other nodes in the network. Accordingly, the nodes 53 and 63 use the bitstream 52 for the communication with other nodes, while the bitstream 51 is only used for the reading of data.

In FIG. 7, two bitstreams 51 and 52 are shown arriving to a first node 53. In the node 53 the bitstream 51 is tapped for reading via the carrier 55, while the bitstream 52 is taken in, as a whole, into the node 53 and there it is optically terminated. In the node 53 the bitstream 52 is further transmitted electronically through the node, while data generated in node 53 is added or written into the bitstream (54), which is then further transmitted optically downstream as the modified bitstream 56. The bitstream 56 is tapped for reading via the carrier 57 by the node 59. The bitstream 51 arrives to node 59. The bitstream 51 is then taken in, as a whole, into node 59, and data generated in node 59 are added to the bitstream (60), which is then further transmitted downstream as the modified bitstream 58. The bitstream 58 is tapped for reading by the node 63 via the carrier 61. The bitstream 56 arrives to the node 63. The bitstream 56 is then taken in, as a whole, into node 63, and data generated in node 63 are added to the bitstream (64), which is then further transmitted as the modified bitstream 62. The bitstream 62 is tapped for reading by the node 67 and is then further transmitted downstream. The bitstream 58 arrives to the node 67. The bitstream 58 is then taken in, as a whole, into node 67, and data generated in node 67 are added to the bitstream 68, which is then further transmitted as the modified bitstream 66.

FIG. 8 shows a first embodiment of how the synchronisation in a network with three parallel bitstreams may be realised. In FIG. 8, a node 71, which is appointed master node, and a bitstream 72 associated to the node 71, which is the trigger bitstream, is shown. The master node adds a trigger pattern and a filling pattern to the bitstream 72. The slave node 73 listens to the bitstream 72, synchronises its bit clock, adds a synchronisation pattern and a filling pattern to a bitstream 74, for which the node 73 is responsible, and synchronises the start of a frame in its bitstream 74 to the start of a frame in the bitstream 72.

The slave node 75 similarity manages the bitstream 76 for which it is responsible. Thus, all the nodes 71, 72, 75, 77, and 78 obtain synchronisation for all the bitstreams 72, 74, and 76. The method is excellent for use in the described networks. As an alternative, this method can be used when every node uses a separate wavelength for transmission, but read from more than one wavelength.

As the frame starting points in the different bitstreams are synchronised at every start of a frame, the bitstreams will not drift in relation to each other.

FIG. 9 shows a cecond embodiment of how the synchronisation in a network with three parallel bitstreams may be realised. A master node, for instance a cluster representative as discussed above, synchronises the bitstream on a wavelength λ3, which is used in the first cluster C4 of nodes. The bitstream of cluster C4 is in this example used as a reference for the synchronisation of clusters C8 and C5. The cluster C8 uses another wavelength λ1, while the cluster C5 reuses the same wavelength λ3 as is used by the cluster C4 after it has been blocked somewhere between clusters C4 and C5. The bitstream of cluster C8 is in this example used as a reference for the synchronisation of the cluster C6. The cluster C6 uses another wavelength λ2, and the bitstream of cluster C6 is, in turn, used as a reference for the synchronisation of a cluster C9, which reuses the same wavelength λ1 as is used by the cluster C8 after it has been blocked somewhere between clusters C8 and C9. Finally, the bitstream of cluster C5 is used in this example as a reference for the synchronisation of the clusters C7 and C10, wherein the cluster C7 reuses the same wavelength λ2 as is used by the cluster C6, after it has been blocked somewhere between clusters C6 and C7, and wherein the cluster C10 reuses the wavelength λ1 which is used by the cluster C9, after it has been blocked somewhere between clusters C9 and C10.

As is understood, the invention is not limited to the embodiments described above and shown in the drawings, and alterations and modifications therof may be made within the limits of the enclosed patent claims. Nor is the invention limited to DTM networks, but can be used in other types of networks that use cycles and time slots of arbitrary sizes.

1. Method for transferring data in time slots in at least two parallel bitstreams along one or more shared optical media between nodes in a time multiplexed network, comprising the steps of:
reading, in a node, at least one incoming of said bitstreams as a whole;
preventing further optical propagation of said incoming bitstream along the shared medium;
regenerating and transmitting the bitstream as an outgoing bitstream from the node; and
arranging at least one other of said parallel bitstreams to bypass said node without regeneration or essential modification thereof.

2. Method as claimed in claim 1, wherein said node is arranged to write data into at least one of the time slots in said at least one incoming bitstream, comprising the step of writing said data into said time slots in the outgoing bitstream association with said regeneration.

3. Method as claimed in claim 1 or 2, wherein said shared medium comprises an optical waveguide and wherein several nodes are arranged to communicate on a first wavelength in said shared medium.

4. Method as claimed in any one of the preceding claims, wherein said network is circuit-switched.

5. Method as claimed in any one of the preceding claims, wherein said node is arranged to read time slots of said other bitstream, which thus passes said node without being essentially modified or regenerated.

6. Method as claimed in any one of the preceding claims, wherein said at least one bitstream and said other bitstream are transferred on two different wavelengths in an optical waveguide.

7. Method as claimed in any one of claims 1-5, wherein each of said at least one bitstream and said other bitstream is transferred in a respective optical waveguide.

8. Method for transferring data via a shared medium between nodes in a time multiplexed network according to any one of the preceding claims, wherein:
data are transferred in time slots in a first and a second bitstream;
the first and the second bitstream are transferred using wavelength division multiplexing;
the first and the second bitstream arrive at a node on a first and a second wavelength via at least one optical carrier;
the wavelengths are separated into the first wavelength V1, transferring the first bitstream, and the second wavelength V2, transferring the second bitstream;
the first wavelength V1 is converted into electronic form and prevented from further propagation to other nodes;
data generated in said node is written into predefined time slots in the first bitstream, resulting in a modified bitstream;
the modified first bitstream is converted into optical form having the wavelength V1;
the second wavelength V2, transferring the second bitstream, is brought together with the first wavelength V1, transferring the modified first bitstream, for further propagation to other nodes.

9. Method as claimed in claim 7, wherein the modified first bitstream is generated using a laser.

10. Method as claimed in any one of claims 1-3, wherein said bitstream is transferred using an electronic conductor and wherein further propagation of the incoming bitstream is prevented by an electronic disconnection of the conductor.

11. Method as claimed in any one of claims 1-9, wherein said time multiplexing is performed using Dynamic Synchronous Transfer Mode.

12. Device for transferring data in time slots in at least two parallel bitstreams along one or more shared optical media between nodes in a time multiplexed network, comprising:
receiving means for reading at least one incoming of said bitstreams as a whole;
filtering means for preventing further propagation of the incoming bitstream along the shared medium; and
regenerating means for regenerating and transmitting the bitstream as an outgoing bitstream;
said device being arranged to pass at least one other of said parallel bitstreams by said node without regeneration or essential modification thereof.

13. Device as claimed in claim 12, comprising writing means for writing data into at least one of said time slots in the outgoing bitstream in association with said regeneration.

14. Device as claimed in claim 12 or 13, comprising reading means for reading time slots of said other bitstream.

15. Device as claimed in claim 12, 13, or 14, wherein said shared medium is an electronic conductor.

16. Device as claimed in claim 12, 13, 14 or 15, wherein said shared medium comprises an optical waveguide in which each of said at least one bitstream and said other bitstream is transferred on a respective wavelength.

17. Device as claimed in claim 12, 13, 14, or 15, wherein said shared medium comprises at least two optical waveguides, said at least one bitstream being transferred on a first optical waveguide and said other bitstream being transferred on a second optical waveguide.

18. Method for synchronising communication in time slots in a time multiplexed network, wherein data is transferred in two or more parallel bitstreams, comprising the steps of:
generating a first bitstream in a first node;
providing the first bitstream with a synchronisation pattern defining a frame rate;
generating at least one second bitstream in a second nod; and
synchronising, in said second node, the start of a frame in the second bitstream to the start of a frame in the first bitstream.

19. Method as claimed in claim 18, comprising the steps of:
generating a third bitstream in a third nod; and
synchronising, in said third node, the start of a frame in the third bitstream to the start of a frame in the first or second bitstream.

20. Method as claimed in claim 18 or 19, comprising the step of synchronising essentially every nodes bit clock to any one of said bitstreams.

21. Method as claimed in claim 18, 19 or 20, wherein the first bitstream is also provided with a filling pattern.

22. Method as claimed in any one of claims 18-21, wherein each bitstream is transferred on a separate wavelength.

23. Method as claimed in any one of claims 18-22, wherein said time division multiplexing is performed using Dynamic Synchronous Transfer Mode.

24. System for synchronisation of communication in time slots in parallel bitstreams in a time multiplexed network, comprising:
a first node, called master node, being arranged to generate at least a first bitstream and to provide the first bitstream with a synchronisation pattern to define a frame rate;
a second node, called slave node, being arranged to generate at least one second bitstream and to synchronise the start of a frame in the second bitstream to the start of a frame in the first bitstream.

25. System as claimed in claim 24, comprising a third node being arranged to generate a third bitstream and to synchronise the start of a frame in the third bitstream to the start of a frame in the second bitstream.

26. System as claimed in claim 24 or 25, comprising one or more other nodes being arranged to synchronise their bit clocks in accordance with any one of said bitstreams.

27. System as claimed in any one of claims 24-26, wherein said network is a circuit-switched network in which said parallel bitstreams are formed using different wavelengths in an optical waveguide.

28. Method for using time slots in a time multiplexed network, comprising:
dividing nodes in said network into clusters;
using a first bitstream for communication between nodes in a first cluster;
preventing propagation of the first bitstream from the first cluster to other clusters.

29. Method as claimed in claim 28, wherein a node representative is appointed for each cluster, said node representative using at least one other bitstream for communication with other clusters.

30. Method as claimed in claim 28 or 29, wherein further propagation of said first bitstream is prevented by a disconnection.

31. Method as claimed in claim 28 or 29, wherein further propagation of said first bitstream is prevented by a passive optical filter.

32. System for using time slots for transferring data via a shared medium in the form of an optical waveguide in a time multiplexed network, characterised by:
the nodes in said network being divided into clusters;
a first wavelengths being allocated for communication between nodes in a first cluster;
and comprising means for preventing communication transferred on said first wavelength between nodes in said first cluster from propagating to other clusters using the same wavelength.

33. System as claimed in claim 32, wherein a node in said first cluster, called master node, is arranged to synchronise communication on the wavelength or wavelengths being used within the cluster.

34. System as claimed in claim 32 or 33, wherein each cluster comprises a node representative which uses a second wavelength for communication with other clusters.

35. System as claimed in claim 32, 33, or 34, wherein said network is circuit-switched.

36. System as claimed in any one of claims 32-35, wherein said network is a circuit-switched wavelength division multiplexing network.

37. System as claimed in any one of claims 32-35, wherein said network is a circuit-switched space division multiplexing network.

38. System as claimed in any one of claims 32-37, wherein said means for preventing further propagation comprises a disconnection.

39. System as claimed in any one of claims 32-37, wherein said means for preventing further propagation comprises an optical filter.
